(19) United States
(12) Patent Application Publication
(10) Pub. No.: US 2026/0360185 A1
(43) Pub. Date: Nov. 12, 2026

(54) CONTEXT-AWARE MULTIMODAL BEHAVIORAL CUE MONITORING OF VIDEO COMMUNICATIONS FOR AUTOMATED COMPLIANCE ENFORCEMENT

(71) Applicant: NICE LTD., Ra'anana (IL)

(72) Inventors: Rajendra CHOUDHARY, Pune (IN); Abhinav VIJAYVERGIYA, Ajmer (IN); Nitin VATS, Faridabad (IN)

(21) Appl. No.: 19/205,240

(22) Filed: May 12, 2025

(51) Int. Cl. G06V 40/20; G06V 10/44; G06V 20/40; G06V 20/52; G06V 40/16; H04N 7/15

(52) U.S. Cl. CPC G06V 40/20; G06V 10/44; G06V 20/49; G06V 20/52; G06V 40/174; H04N 7/155

(57) ABSTRACT

A fraud detection system and methods are provided that are configured to automatically detect compliance violations from behavioral cues performed by users during video communications. The system includes a processor and a computer readable medium operably coupled thereto, the computer readable medium comprising a plurality of instructions stored in association therewith that are accessible to, and executable by, the processor, to perform operations which include accessing a video communication, determining, by a first large language model (LLM), that the video data includes suspicious activity, identifying, based on the feature data and a second LLM, one or more segments meeting or exceeding a threshold for the suspicious activity, performing a gesture recognition process on the segment(s), generating a summary having an analysis of one or more behavioral cues in the segment(s), and outputting the summary for an automated compliance action.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) systems and models including large language models (LLMs) and other machine learning (ML) models, such as those that may be used for anti-money laundering (AML) and fraud detection with financial institutions. More specifically the present disclosure relates to a system and method for automatically identifying user behavioral cues, such as gestures, exchanged during video communications that may be indicative of fraud.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Financial crimes, including money laundering and fraud, threaten the financial industry by undermining trust, integrity, and stability that users have in their financial institutions. Financial institutions have responded by implementing various risk management and investigation techniques to mitigate these risks. However, the ever-evolving landscape of financial crimes presents an ongoing and formidable challenge when identifying and investigating financial crimes. For example, traditional fraud and risk alert investigation processes and procedures rely heavily on manual processes and efforts by investigators, as well as analysis of transaction logs and histories, computing system and network traffic logs, and other copious amounts of data. As such, fraudsters may find unique and evasive ways of sharing data and conducting fraud including transmitting data in manners that may by undecipherable and/or undetectable by current automated risk models and systems. This may include transmitting visual data over video communications, such as conference calls and other video calls, recordings, and the like between users. Thus, developing AML and fraud detection systems that are accurate, responsive, and adaptive present formidable challenges to financial institutions.

With the increasing use of video communications during virtual meetings and video calls, user behaviors in visual data poses a unique challenges for compliance and data security in different industries and companies, such as banking and financial institutions. For example, while the majority of video communications may be used for legitimate and valid communications, and may greatly increase the ability of users to interact, personalize, and develop relationships over long distances, there remain fraudsters who find new and illicit means of transmitting communications between each other through video communications without triggering fraud detection systems that implement text review, speech-to-text or general speech analysis, and the like. One such form is the conveyance of gestures and bodily movements, or “behavioral cues” that convey information between parties without generating audio and/or text information for analysis. As such, employee behavior during communications, whether in person, over phone calls, or in video meetings, can signal potential risks or violations.

Existing compliance systems rely on natural language processors (or natural language processing, both collectively referred to as “NLP”) or rule-based monitoring. These fraud detection services may miss out on key features like audio tone and gestures, which can help to understand the emotional state of the participants and provide context to the conversation. Employees engaging in misconduct might exhibit changes in their tone, speech patterns, or gestures. Without a multimodal approach that considers video, audio, text, and the like, compliance monitoring systems fail to capture these subtle behavioral shifts that could signal unethical activity.

Conventionally, rule-based and NLP-driven compliance monitoring systems often generate false positives by misinterpreting harmless conversations as violations, leading to unnecessary investigations and wasted resources. As such, businesses and compliance enforcement institutions are discovering that it is crucial to ensure video communication activities are captured, monitored, and securely analyzed and stored in compliance with regulatory requirements. However, the complexity of capturing and archiving video data across multiple communication platforms adds significant complexity for compliance teams. Recording of this data may require significant resources and, after recording, it may be time consuming to manually review and inspect video recordings. As such, manually monitoring many video calls occurring daily for compliance purposes may be impossible due to the limited human resources and available time.

Therefore, there is a need for effective solutions and strategies that address compliance and data security concerns associated with video communications between parties in a business, as well as between businesses. This includes establishing effective means and systems for monitoring behavioral cues in call recordings. When analyzing behavioral cues, the solutions should further analyze emotional tone, intentions, and gestures, which provides insights into the context behind behavioral cues and changes by users. This need extends to detecting potential compliance issues, alerting authorities, managers, administrators, or other compliance enforcement users, as well as systems of compliance incidents, and providing those user and/or systems with options for taking remedial actions, such as investigation of alerted content.

Further, there is a need to develop processes to remove noise in the content and specifically analyze user gestures and other body language or behavioral cues indicative of potential fraud or malicious conduct, thereby providing those systems and users with more proactive compliance and fraud detection, while minimizing security risks. Therefore, there is a need to provide an intelligent and automated system that may monitor behavioral cues in call recordings and other video communications, analyze emotional tone, intentions, and gestures, and provide insights into context behind behavioral changes, thereby assisting compliance systems with detecting potential compliance issues. The present disclosure below is believed to provide various solutions to address these problems.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified diagram of a processing flow between system components for detecting behavioral cues in video communications according to some embodiments.

FIG. 3 is a simplified diagram of the system components and processing modules from FIG. 2 shown in further detail according to some embodiments.

FIG. 4 is a simplified diagram of an exemplary processing flow for detecting behavioral cues in video communications using a multimodal artificial intelligence system for automated compliance enforcement according to some embodiments.

FIG. 5 is a simplified diagram of an exemplary flowchart for context-aware behavioral cue monitoring using multimodal AI models including LLMs for automated compliance enforcement in video communications according to some embodiments.

FIG. 6 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

As discussed herein, a service provider, such as one operating a fraud detection and notification system, may improve the digital engagement, capabilities, and assistive computing systems of compliance officers with AI capabilities for automated compliance of video communications where users may utilize visual signals, motions, communications (e.g., sign language), and similar forms of visual content or activity to exchange information and/or communicate. Since the visual information exchanged of users' motions, communications, or other signals may not be immediately apparent from review of audio, a transcript, or other text data of the video communications, such visual data may be used to perpetrate fraud while escaping the purview of modern anti-fraud practices and techniques.

With the increasing use of video calls during virtual meetings, conducting communications and sharing of data in this manner poses challenges for compliance and data security in different industries and companies, such as banking and financial institutions. While video calls, meetings, and conferences enhance collaboration and information sharing, video calls also introduce risks related to behaviors and body language, unauthorized data access, potential data leaks, and compliance recording failures. As such, businesses and compliance enforcement institutions are discovering that it is crucial to ensure video communications and other visual activities between users during communications are captured, monitored, and securely stored in compliance with regulatory requirements. However, the complexity of capturing and archiving video data across multiple communication platforms adds further complexity for compliance teams. Recording, handling, and storing video data may require significant resources and, after recording, it may be time consuming to manually review and inspect video recordings

Video conferencing and video calls or communications introduce risks of data, images, links, and the like being presented in a manner that may not be captured during text and/or audio recordings. For example, gestures and/or hand or body movements may not be apparent from reviewing shared data, transcripts, and other text information for exchanged during video calls. Employee behaviors and body language/movements during video communications, whether in person, over phone calls, or in video meetings, can signal potential risks or violations. Instead, reviewers would need to identify the illegal, illicit, or fraudulent activity occurring in videos and images from direct analysis of the video and/or images. However, existing compliance systems either rely on natural language processors/processing (NLP) or rule-based monitoring, which may miss out on key features including audio tone and gestures which can help to understand the emotional state of the participant and provide context to the conversation.

As such, the AI capabilities of the fraud detection system discussed herein may reduce the risk of fraud by improving detection of fraudulent activity from video data and other video or visual information exchanges, communications, motions, and signals. While it may be difficult, if not impossible, for a compliance officer to go through all recordings of video calls to detect compliance issues, the fraud detection system discussed herein may be implemented with a multimodal AI system, which may include one or more multimodal LLMs, to detect exchanges of behavioral cues, such as gestures, that are indicative of fraud and/or may be used for perpetrate fraud in most, if not all, video recordings generated from video communication between users. This may enable organizations to identify and mitigate risks associated with visual content transmitted and shared during video communications of user behavioral cues. As such, the fraud detection system may improve the overall safety and privacy of online communication platforms, as well as provide streamlined and higher-accuracy compliance processes through automated detection and notification mechanisms. These automated processes may save a significant amount of time, computing resources, and manual efforts required for reviewing video communications compared to conventional and standard review and compliance enforcement processes. As such, the partly or fully automated processes described herein can advantageously increase accuracy and security with computing systems and video communication applications.

A service provider, such as a risk and fraud detection system, may provide improved AI capabilities for automated compliance alerts of visual content exchanged during video calls, conferences, or other communications, generally referred to as “video communications”, recorded as “video recordings”, herein. These AI capabilities may reduce the risk of illegal, illicit, or unauthorized data from being shared during video communications, while identifying occurrences of such data being shared through gestures, mouth, hand, head, or body movements, movements with objects (e.g., holding up a check or financial instrument), or other behavioral cues. Conventional systems focus heavily on text data, missing out on key behavioral signals from audio and video interactions as well as non-verbal cues from facial expressions and hand gestures. Furthermore, conventional systems do not provide a clear context or summary of what led to suspicious behavior, making it hard to investigate or take action on alerts.

The fraud detection system as described herein may provide automated compliance management and enforcement for video communications where users may exchange behavioral cues, such as gestures and other motions or body, face, or other movements. The fraud detection system may utilize multimodal LLMs or other multimodal AI models for detection of behavioral cues by users in video communications, such as based on visual appearances, motions, and activities of users. These multimodal LLMs may, with additional deep learning models for specific gesture recognition, make determinations of whether those behavioral cues may be indicative of fraud. The system may include various components including one or more for a data capture, recording, and data recording retrieval, where recordings of video communications, conferences, chats, and such communication sessions are recorded, stored, and later fetched. A recordings retrieval component may preprocess the recording and perform operations that may include removing noise and/or enhancing image quality. A further component may diarize the audio and video of individual speakers from a conference meeting, thereby detecting each individual speaker, their speech, and their corresponding video and visual appearance, motions, activities, changes, and other behavioral cues. A multimodal model may detect expressions, audio tone, and intentions of individual speakers at different timestamps.

Thereafter, the multimodal model and/or another model and component may match the expressions, audio tone, and intentions of individual speakers with predefined values indicating suspicious activity, thereby detecting whether behavioral cues are indicative of fraud. In this regard, a trained deep neural network (DNN) model may be configured to detect hand gestures, or other bodily movements, gestures, or the like, that may indicate suspicious actions and/or activities during video communications, such as a user having their fingers crossed, thumbs down, etc., which may be detected or correlated with corresponding timestamps, speech, shared text, or the like. A further algorithm and/or model may be trained to detect changes in emotional cues of individual speaker, which may be used with an LLM or other generative AI to generate a summary of the interaction that led to the change in “behavior” or the activity indicative of fraud, misdirection, or other malicious, fraudulent, or deceptive intent. For example, the summary may provide timestamps and information for when, where, and how the user changes their actions and/or speech from normal to suspicious based on their behavioral cues. In some embodiments, the summary may also provide an indication that a second, different user has taken the place of the original user. The LLM or other generative AI may further explain the context of the users'discussion(s) and/or video communications in order to provide information regarding the behavioral cues that are indicative of fraud. For example, in a scenario where two speakers are discussing client retention and their portfolio performance, if the first speaker changes their behavior from normal to suspicious after 25 seconds, the LLM may provide an explanation for the reasons behind this change and the context of the discussion, as well as the behavioral cues that caused the change in perception and classification of the user and any other relevant data.

The fraud detection system may implement, through the aforementioned components and modules, a process by which video communications may be analyzed for determination of potentially fraudulent activity based on behavioral cues and other information exchanged and/or presented during the video communications. For compliance review and enforcement, a module may be utilized to execute processes and operations for remedial, corrective, and/or preventative actions that may seek to mitigate, reduce, and/or eliminate the potential or actual fraud from occurring, causing further harm, or continuing. This may be done for the security of data with the service provider and/or for compliance with various legal or corporate requirements. As such, a rating of the video communications may be determined for alert generation. This rating may be added as metadata with each of the video communications or a grouping thereof, which may then be collected and stored. In some embodiments, the metadata may be stored in association with the video recording and/or compliance review information for the video recording for retrieval of corresponding data. Once finalized, a review and compliance system may be utilized to determine if any alerts require generation and/or transmission to other users and/or systems for compliance review, enforcement, or other action with respect to the video recording, one or more users within or in the recording, and/or context or content of the video recording.

The content identification and compliance evaluation framework of the fraud detection system may utilize one or more generative AIs, large language models (LLMs), reinforcement ML models, recommendation systems, decision-making algorithms, and other related components to provide intelligent analysis of video communications including analysis of behavioral cues. These AI models and systems may further provide intelligent scoring and predictive actioning for compliance alerts and other steps that can be taken to mitigate or reduce fraud and/or loss caused by video communications being exchanged that include behavioral cues used to conduct fraud or other malicious activities. ML models may be built on different tenants of a fraud detection and/or ML modeling system, such as different financial institutions, using historical or past activities, transactions, and/or other model training data. As such, the ML models may be implemented in fraud detection processes to assist these tenants of the fraud detection and/or ML modeling system.

As such, the multimodal AI system may include multimodal LLMs, deep learning models and DNNs, and the like, which may be used to increase the digital engagement of compliance officers with video communications. This system may uniquely integrate audio, visual, and gestural cues to provide a more holistic and context-aware assessment of user behavior, such as employees, customers, and other users of a business, company, or other entity that may engage in fraud harmful to such entity. Conventionally, hand gesture recognition is not specifically trained for financial misconduct detection, and financial compliance tools merely flag predefined keywords or sentiment shifts. However, this conventional process lacks contextual reasoning behind suspicious behaviors. In contrast, the system, as described herein, intelligently triggers gesture detection at behaviorally significant timestamps and correlates multimodal cues (e.g., a nervous tone with hand concealment gestures) to explain the reason behind a user's intent. This provides an understandable explanation of “why” behavioral cues are suspicious, unlike conventional systems that may often trigger false alarms due to isolated verbal cues without considering body language. By cross-referencing speech, facial expressions, and hand movements, the system therefore improves accuracy and reliability in detecting suspicious activities, and simplifies the ability to flag suspicious activities when body language cues match a change in language that is, e.g., suspicious language or in response to a particular question or series of questions.

As such, the embodiments described herein provide methods, computer program products, and computer database systems for an AI system that programmatically processes, evaluates, and provides compliance alerts based on behavioral cues in video communication(s). The framework of intelligent decision automation for fraud detection and other compliance investigations may provide businesses and investigators with a powerful tool for effectively identifying, investigating, prosecuting, minimizing the risks or negative outcomes of, and preventing, each such fraudulent or noncompliant video communication. This provides a comprehensive, efficient, and accurate fraud detection and automated compliance system that may more quickly and/or accurately detect and prevent fraud. Many industries, particularly finance, healthcare, and legal sectors, have stringent regulatory requirements for communication monitoring. For instance, the global regulatory technology (RegTech) market is estimated to grow significantly, with a large portion dedicated to communication compliance, which may greatly benefit from behavioral cue monitoring for compliance enforcement. Consequently, the present AI system may analyze such data and properly consider the context and visual activity present in the video communications for more accurate, efficient, and timely decision-making, predictions, and inferences with regard to potential fraud.

As such, and according to some embodiments, in an ML system accessible by a plurality of separate and distinct organizations, ML algorithms, features, and models are provided for compliance alerts and enforcement of video communications through analysis of behavioral cues of users, thereby providing faster, more efficient, and more precise ML detection of fraud and other activities that violate or attempt to avoid compliance rules, regulations, laws, and their corresponding detection and enforcement systems.

### Example System and Computing Environment

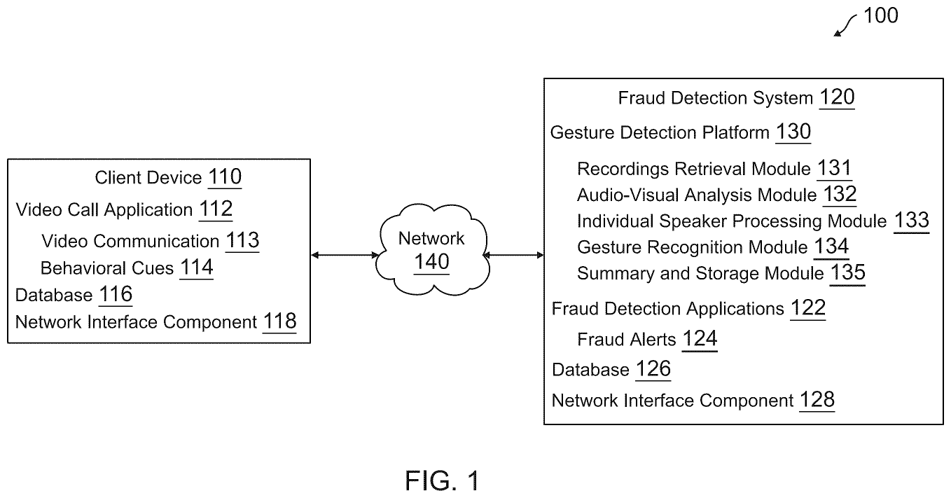

The system and methods of the present disclosure can include, incorporate, or operate in conjunction with, or in the environment of, an ML engine, model, and intelligent system, which may include an ML or other AI computing architecture that provides automated and programmatic evaluation of one or more video communications for behavioral cues and contextual data that may indicate fraudulent activities. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML models, NNs, and other AI architectures have been developed to improve predictive analysis and classifications by systems in a manner similar to human decision-making, which increases efficiency and speed in performing predictive analysis on datasets requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a client device 110 and a fraud detection system 120 that interact over a network 140 to provide intelligent fraud detection using a fraud detection platform for visual content extraction, processing, and scoring based on user behavioral cues found in video communications. Fraud detection system 120 may extract such content from video communications, such as video calls and/or video conferences, where the content may be extracted for analysis and compliance enforcement, as discussed herein. In other embodiments, environment 100 may not have all of the components listed and/or may have other elements instead of, or in addition to, those listed above. In some embodiments, environment 100 is an environment in which a gesture detection platform 130 may execute ML models to perform identification and analysis of gestures and other behavioral cues for automated compliance alerts. As illustrated in FIG. 1, fraud detection system 120 might interact via a network 140 with client device 110 to extract, process, and score visual content of individual, diarized, users to gesture analysis and determination of fraudulent activities or actions being performed using, in part or entirely, gestures and other behavioral cues, which may allow for automated compliance alerts.

For example, in fraud detection system 120, fraud detection applications 122 may process data and return fraud alerts 124 from fraud detection and risk analysis using one or more ML models that intelligently detect fraud conducted using gestures and other behavioral cues performed by the users in the video communications. It should be understood that this disclosure encompasses one or more users in a single video communication, as well as one or more users (the same or different) across a plurality of video communications. As used herein, video communications may correspond to any audiovisual content in which a visual image and/or video (e.g., series of images, such as a set of frames making up a video when each image is quickly displayed (e.g., as measured in milliseconds or less than a second) in a sequence). Video communications may include audio content, but do not necessarily require such content and audio content may be filtered out and/or removed from video communications having audio. Similarly, text data and other content or data may be shared, exchanged, or provided in association with video communications, such as through a chat window or interface, direct or private messages, and the like, which may or may not be a part of the video communications, and may similarly be extracted, filtered, and/or removed if desired or necessary. Video recordings may therefore correspond to data recordings of communication sessions over a video communication channel that occurs between users, and therefore may capture a user's physical appearance, activities, and/or actions. Behavioral cues may correspond to gestures of users, which may correspond to actions, activities, movements, or the like of the user, body part of the user, and/or object in possession of the user. As such, behavioral cues and gestures may be interchangeably utilized herein to refer to such visual activities and/or actions of users that may be captured in video recordings

ML fraud detection engines may use ML models that are trained for fraud detection generally, on a per-tenant basis, and/or based on other training data. The ML models may be trained to identify fraud and generate, transmit, or issue fraud alerts 124 using offline and/or online ML models, where offline ML models may be trained and deployed based on a training data set and online ML models may provide continuous learning and adaptation to new and changing datasets, such as emerging trends using live or streaming data. Using these ML models, fraud detection system 120 may be utilized to provide faster, more efficient, and more accurate fraud detection or other ML operations to tenants, customers, and other users or entities via fraud detection applications 122. Fraud detection applications 122 may be executed to detect fraud being conducted in video communications, which may include analysis of behavioral cues from visual data of users and may cause issuance of fraud alerts 124 for potential and/or detected fraudulent activity and/or conduct. In some embodiments, fraud detection applications 122 may be used with audiovisual content and media, such as video calls and/or conferences, as well as other visual data exchanges and transmissions, which may be live between users or asynchronous and recorded. Fraud alerts 124 may be generated for and/or based on multimodal LLM analysis of behavioral cues from video communications.

To identify, detect, and/or investigate real or potential fraud, as well as perform compliance enforcement of laws, rules, and regulations, gesture detection platform 130 may be provided and utilized to intelligently detect and score visual content shared by a user, or more typically, between two or more users during a video call or other video or media communication session (e.g., instant messaging, live chat sessions, VoIP or VoLTE communications, etc.), as discussed herein. In asynchronous communications, the content may be shared by a single user and a second user may share content in a reply, for example. The video communications may exchange visual content and data having an appearance or visual of a user and/or portion of a user that may be used to convey information to another user, including information that may be used to perpetrate fraudulent activity or conduct by or between users. Fraud detection applications 122 may therefore provide fraud detection services for analysis of video calls and other video or media communications and audiovisual content. These computing services may be provided to customers, tenants, and other users or entities accessing and utilizing fraud detection system 120. ML fraud detection engines of fraud detection applications 122 and gesture detection platform 130 may be executed by fraud detection system 120 and/or provided for use by other ML systems and models, such as those managed by separate computing systems, servers, and/or devices (e.g., tenant-specific, or controlled servers and/or server systems that may be separate from fraud detection system 120 discussed herein).

Client device 110 may include an application 112 that engages in a video communication 113 and shares or transmits behavioral cues 114 during video communication 113. Behavioral cues 114 may therefore correspond to a user's appearance and/or visual content or data of the user that was shared, presented, or exchanged during video communication 113 and which may require analysis by gesture detection platform 130 for potential fraudulent conduct or activity. Gesture detection platform 130 may utilize determined scores for compliance alert actions, which may include fraud alerts 124, that enforce compliance and fraud laws, rules, regulations, and other requirements of the tenants, customers, or other users or entities utilizing fraud detection system 120, as well as their corresponding regulatory or governing entities.

Gesture detection platform 130 may therefore include a recordings retrieval module 131, an audio-visual analysis module 132, an individual speaker processing module 133, a gesture recognition module 134, and a summary and storage module 135. Recordings retrieval module 131 may be configured to request and fetch recordings from a recording server, such as by calling the recording server with a fetch request for one or more recordings that are to be processed. The recordings may be retrieved from the recording server by recordings retrieval module 131 for a specific time period and/or upon availability after completion of (or while streaming) video call sessions and events that were previously recorded. Audio-visual analysis module 132 may then process the recordings by performing an initial analysis to determine if any indications of fraud are present. Audio-visual module 132 may utilize a multimodal LLM to analyze the entire video for indications of fraud, and further perform speaker diarization whereby each speaker, or other user in the video communications is identified and segmented separately so that each user may be identified when that user speaks, as identified through metadata and/or timestamps in the video communications. Speaker diarization by the multimodal LLM of audio-visual analysis module 132 may therefore correspond to a process of identifying different individual speakers and separating their speech, as well as video, segments, without requiring prior knowledge of the speaker and/or portion of speech by the speaker. Thus, the multimodal LLM may be trained and capable of speaker diarization.

If the video communication analyzed by audio-visual analysis module 132 does not include indications of fraud, the video communication may not require further processing. In such embodiments, the video recording may be approved, stored, and/or indicated as compliance or non-fraudulent. However, if an indication of fraud is detected, including an indication caused by gestures or other behavioral cues, individual speaker processing module 133 may be used to extract text, audio, and visual features for the first or a second multimodal LLM, which may compare the feature with suspicious values to extract relevant sections of the video communications that may be associated with the indication(s) of fraud. Individual speaker processing module 133 may extract data containers, files, objects, timestamps, metadata, and the like for the relevant sections, which may be provided to gesture recognition module 134.

Gesture recognition module 134 may be configured to receive the data containers and collect relevant metadata from individual speaker processing module 133 and the video communication for timestamps, text extracted from images, confidence scores, types of detected anomalies, identified sensitive and confidential words, ratings of sensitivity, and other relevant data that may be initially detected and identified by the multimodal model(s). Gesture recognition module 134 may include a DNN or other deep learning model that may be configured to specifically recognize gestures, their context, and their meaning, and make accurate predictions as to the use of the gesture, including whether the gesture was utilized for fraud or malicious, fraudulent, unauthorized, illegal, or illicit purposes. Gesture recognition module 134 may provide an output score and/or prediction, which may include a recognition of any gestures and the gestures' meaning or context, as well as any model score explanation or information, such as feature dependence and/or individual feature scoring, weight, or importance in the output decision.

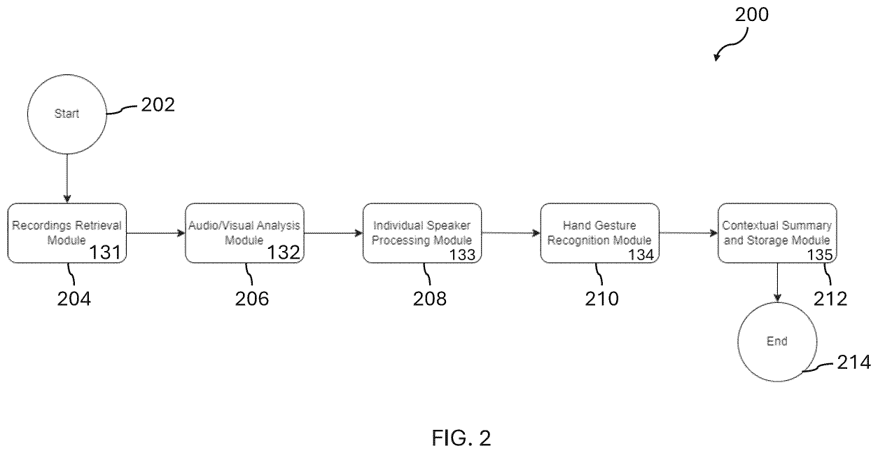

As such, summary and storage module 135 may receive the output data from gesture recognition module 134 and may generate a summary and a data container, file, and/or object(s) for storage of the video communication, one or more of fraud alerts 124 generated for the video communication, and/or other data resulting from the analysis of the video communication for fraud that includes usage of behavioral cues. In some embodiments, summary and storage module 135 may determine a compliance alert action based on the score or rating and a corresponding threshold or other action requirement. The compliance alert action may include determining, as well as executing, actions with regard to whether an alert needs to be generated, a video communication recording or user is to be flagged, a compliance agent or other user is to be alerted for potential fraud, or a video call may be authorized as compliant. The operations, components, and models of gesture detection platform 130, such as those utilized for content extraction, identification, and scoring, are discussed in further detail below with regard to FIGS. 2-5.

For ML models (e.g., decision trees and corresponding branches, NNs, clustering operations, etc.) including ML models of fraud detection applications 122 and/or gesture detection platform 130, the models may be trained using training data, which may correspond to stored, preprocessed, and/or feature transformed data from images or videos of gestures, fraud detection results and/or fraudulent activities, fraud investigations, and/or compliance requirements, as well as other relevant data including video, audio, images, text, and the like. With continuous and/or reinforcement training, live streaming data from one or more production, live, and/or real-time computing environments and/or feedback from different entities may be used. Model training and configuring may include performing feature engineering and/or selection of features or variables used by ML models. Features or variables may correspond to discreet, measurable, and/or identifiable properties or characteristics.

ML models of fraud detection system 120, such as those used by fraud detection applications 122 and/or gesture detection platform 130, may be trained using one or more ML algorithms, operations, or the like for modeling (e.g., including configuring decision trees or neural networks, weights, activation functions, input/hidden/output layers, and the like). Thus, one or more ML models, NNs, or other AI-based models and/or engines may be trained for fraud detection or another ML task. The training data may be labeled or unlabeled for different supervised or unsupervised ML and NN training algorithms, techniques, and/or systems. Fraud detection system 120 may further use features from such data for training, where the system may perform feature engineering and/or selection of features used for training and decision-making by one or more ML, NN, or other AI algorithms, operations, or the like (e.g., including configuring decision trees, weights, activation functions, input/hidden/output layers, and the like).

An ML model may then be trained using a function and/or algorithm for the model trainer, as well as other ML systems, trainers, and operations for model and/or engine training and development. The training may include adjustment of weights, activation functions, node values, and the like. After initial training of ML models using supervised or unsupervised ML algorithms (or combinations thereof), ML models may be evaluated and/or released in a production computing environment. ML models may be deployed to take and process input data for model features and predict labels or other classifiers from the input data. Offline ML models may be released and implemented in a static manner, such as without updating and/or updating through release of new versions that may be deployed at specific times and by bringing one or more ML models of fraud detection applications 122 and/or gesture detection platform 130 offline for updating, versioning, patching, and the like. In contrast, deployed online ML models may be initially trained and/or configured for training, and may continuously learn as data is streamed and/or provided during decision-making.

One or more client devices and/or servers (e.g., client device 110 using application 112) may execute a web-based client that accesses a web-based application for fraud detection system 120, or may utilize a rich client, such as a dedicated resident application, to access fraud detection system 120, which may be provided by fraud detection applications 122 and/or gesture detection platform 130 to such client devices and/or servers. Client device 110 and/or other devices or servers may utilize one or more APIs to access and interface with video communication application and platforms, which may record and/or share video communication 113 processed by fraud detection applications 122 and/or gesture detection platform 130 in order to identify, score, and evaluate visual content of gestures and other behavioral cues in video communications and other media content and/or communication sessions using the operations discussed herein.

In some embodiments, client device 110 may interface directly with fraud detection system 120 and/or another system associated with fraud detection system 120 via video call application 112 to perform video communication 113 with one or more other users and/or endpoints. However, in other embodiments, other communication platforms may be utilized and fraud detection system 120 may receive data and a recording for video communication 113 through interfacing with such a communication platform. Interfacing with fraud detection system 120 may be provided through fraud detection applications 122 and/or gesture detection platform 130. Further, data stored by database 116 of client device 110 may be utilized and/or shared during video communication 113, such as behavioral cues 114, and database 126 of fraud detection system 120 may store and/or retain information for video communication 113, behavioral cues 114, and/or compliance review and scoring of video communication 113 and behavioral cues 114, such as metadata from OCR data extraction and scoring.

Client device 110 and/or other devices and servers on network 140 might communicate with fraud detection system 120 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between client device 110 and fraud detection system 120 may occur over network 140 using a network interface component 118 of client device 110 and a network interface component 128 of fraud detection system 120. In an example where HTTP/HTTPS is used, client device 110 might include an HTTP/HTTPS client for application 112, commonly referred to as a “browser,” for sending and receiving HTTP//HTTPS messages to and from an HTTP//HTTPS server, such as fraud detection system 120 via the network interface component.

Similarly, fraud detection system 120 may host an online platform accessible over network 140 that communicates information to and receives information from client device 110. Such an HTTP/HTTPS server might be implemented as the sole network interface between client device 110 and fraud detection system 120, but other techniques might be used as well or instead. In some implementations, the interface between client device 110 and fraud detection system 120 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Client device 110 and other components in environment 100 may utilize network 140 to communicate with fraud detection system 120 and/or other devices and servers, and vice versa, which is any network or combination of networks of devices that communicate with one another. For example, network 140 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol. Further, one or more of client device 110 and/or fraud detection system 120 may be included by the same system, server, and/or device and therefore communicate directly or over an internal network.

According to one embodiment, fraud detection system 120 is configured to provide webpages, forms, applications, data, and media content to one or more client devices and/or to receive data from client device 110 and/or other devices, servers, and online resources. In some embodiments, fraud detection system 120 may be provided or implemented in a cloud environment, which may be accessible through one or more APIs with or without a corresponding graphical user interface (GUI) output. Fraud detection system 120 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, client device 110, shown in FIG. 1, executes processing logic with processing components to provide data for video communication 113 processed by fraud detection applications 122 and/or gesture detection platform 130 of fraud detection system 120, such as during compliance reviews and fraud investigations of behavioral cues 114 that may occur and/or be performed during video communication 113 between two or more users. As such, video communication 113 may be processed, and behavioral cues 114 may be detected, scored, and evaluated by gesture detection platform 130. In one embodiment, fraud detection system 120 includes application servers configured to implement and execute software applications as well as optionally provide various related data, code, forms, webpages, platform components or restrictions, and other information, and to store to, and retrieve from, database 126 the related data, objects, and web page content. For example, fraud detection system 120 may implement various functions of processing logic and processing components, and the processing space for executing system processes, such as running applications for fraud investigations and/or compliance review of video calls and other media communications. Client device 110 and fraud detection system 120 may be accessible over network 140. Thus, fraud detection system 120 may send and receive data to client device 110 via network interface component 128. Client device 110 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, client device 110 could include a desktop personal computer, workstation, laptop, notepad computer, PDA, cell phone, or any wireless access protocol (WAP) enabled device or any other computing device capable of interfacing directly or indirectly to the Internet or other network connection. Client device 110 may also be a server or other online processing entity that provides functionalities and processing to other client devices or programs, such as online processing entities that provide services to a plurality of disparate clients. Client device 110 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, client device 110 and all of its components are configurable using applications, such as a browser, including computer code run using a central processing unit such as an Intel Pentium® processor or the like. However, client device 110 may instead correspond to a server configured to communicate with one or more client programs or devices, similar to a server corresponding to fraud detection system 120 that provides one or more APIs for interaction with client device 110.

Thus, client device 110 and/or fraud detection system 120 and all of their components might be operator configurable using application(s) including computer code to run using a central processing unit, which may include an Intel Pentium® processor or the like, and/or multiple processor units. A server for client device 110 and/or fraud detection system 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring client device 110 and fraud detection system 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Context-Aware Multimodal Artificial Intelligence System for Behavioral Cue Monitoring

FIG. 2 is a simplified diagram 200 of a processing flow between system components for detecting behavioral cues in video communications according to some embodiments. Diagram 200 of FIG. 2 includes components of gesture detection platform 130 of fraud detection system 120 that may be implemented for automated compliance reviews and alerts when anomalous, suspicious, and/or fraudulent gestures are detected in one or more video communications and/or audio-visual content extracted from such communications. In this regard, the components in diagram 200 may be used by gesture detection platform 130 when processing video communications to identify and score whether gestures were used to perpetrate fraud, such as whether video communication 113 having behavioral cues 114 include indications of fraud.

Components 131-135 in diagram 200 may correspond to the different data, applications, ML models, databases, user interfaces, and/or other computing system components that may be used for gesture detection platform 130. As such, the input of diagram 200 may correspond to a recording of a video communication, such as video communication 113, which may be recorded and/or obtained from a recording database for compliance analysis. Video communication 113 may be recorded at step 202, which may correspond to a video recording file that may be stored and/or made available to be retrieved from storage using an API call. The API call may correspond to a fetch request by a compliance review handler. In this regard, a service provider, such as a fraud detection system and provider, may utilize a multimodal behavioral analysis along with a dynamic gesture recognition system that monitors employees'actions during video communications and explains the context and reason behind suspicious intention of individual speakers. The multimodal model may correspond to an AI model, such as an LLM or other generative AI, ML model including neural networks NNs, DNNs, and other deep learning algorithms and models, or similar AI including machine-based AI, which may be trained to detect expressions, audio tone, and intentions that occur during video recordings, identified by their timestamps in the recordings, without human input, efforts, or the like.

The system may also be trained to detect financial hand gestures or other behavioral cues that may indicate suspicious actions. Based on the output of the multimodal model, a deep learning model trained for gesture recognition and/or recognition of other behavioral cues may be executed and run to process video data, such as video of the current speaker or user (at the designated time). This may also or instead correspond to the user that is performing the gestures or other suspicious behavior, activity, or behavioral cue at the corresponding timestamp. The resulting output may include a score, as well as a certainty of suspicious activity, which may be used for automated actioning, such as by allowing or ignoring low scoring behaviors and alerting on and/or banning further communications for users with high scoring behaviors during video recordings. Additionally, a generative AI of the multimodal model, such as the LLM trained for the model, may be used to generate a summary of the interaction which led to such behavior and the context.

Once retrieved, recordings retrieval module 131 may, at step 204, perform initial operations to determine whether any indications of fraud are present in the entirety of the video. For example, after a data capture system records a video communication between two or more users, recordings retrieval module 131 may initiate real-time or near real-time risk and fraud detection by retrieving the recording for processing. This processing flow for data processing performed by the fraud detection system may include analyzing the video for suspicious behavior using a first multimodal LLM, checking for hand or other gestures indicative of fraud, scoring those gestures for risk, comparing the scores to a threshold, and classifying the scores, and therefore the gestures, according to the different thresholds (e.g., high, low, medium, etc., risk). With no risk, no further action may be required. However, with detected risk, additional processing may be performed to determine a predicted likelihood of the gesture being used for fraud, and if so, to generate a summary of the risk, fraud, gesture, context, communications, and other information necessary for actioning by automated or manual risk and fraud compliance teams and systems.

For example, initially at step 206, an LLM or other ML model of audio-visual analysis module 132 may, after receiving the recording from recordings retrieval module 131, process the video recording of the video communication using a multimodal LLM or another AI model. This model may correspond to an anomalous detection and/or alert model trained for initial detection of suspicious activity or suspicious behavioral cue identification (e.g., one that may be trained using NotebookLM™ from Google™). As such, this multimodal LLM may perform an initial check of a video, in its entirety, to determine if there is anything suspicious in the video. This initial check at step 206 may be used to determine whether further processing is necessary, and those recordings that do not trigger an alert may be discarded from further review, approved for storage and stored, or otherwise handled as non-fraudulent and/or valid/approved recordings. Whether a behavior cue rises to the level to cause an alert may be determined initially by the alerting LLM or other AI model configured to generate alerts without predicting a score, classification, or the like of the video data.

If a video recording causes an initial alert by the LLM or other AI model at step 206, then a second multimodal LLM or other multimodal ML model may be invoked to perform automated assessment and detailed extraction of the video for gesture analysis, at step 208. This analysis may be performed by individual speaker processing module 133, which may process diarized portions of the video recording for specific users. Specifically, the speakers in the corresponding portions of the video may be identified and independently processed, instead of processing the video as a whole. This allows for a more nuanced, granular, and specific analysis of individual speakers and their gestures to convey information between users or other parties. In this regard, the multimodal model may based on training data, a knowledge base, and/or a corpus or corpora of documents, videos, images, or the like. The multimodal model may be trained to specifically analyze text features for intentions, audio features for pitch, tone, and the like, and visual features for emotions, expressions, gestures, and the like. The multimodal model of individual speaker processing module 133 may segregate and/or segment the video recording per speaker and/or according to each speaker that can be identified. Once segmented, the multimodal LLM or other model may analyze each speaker's video based on the aforementioned factors and/or features. From the multimodal model, audio-visual details may be extracted, which may be flagged when such values meet, match, or are within a threshold similarity (e.g., meet or exceed a threshold score). If flagged, a data structure may be generated that may include an expression, an audio tone, an intention, and identified gestures.

At step 210, a proprietarily trained deep learning model of gesture recognition module 134 may process extracted video segments for each gesture identified by individual speaker processing module 133. The DNN or other deep learning model may be configured for analysis of gestures or other behavioral cues, as well as determination of whether the gestures or other behavioral cues are indicative of fraud and/or are being used in the video to potentially perpetrate fraud (e.g., by showing or conveying sensitive, financial, or confidential data). In this regard, the data structure (e.g., a JavaScript Object Notation (JSON) file or object) may include data indicating a suspicious behavior analysis, as well as confidence score in the analysis. For example, the data in the data structure may, in one example, include: “Duration: 73 seconds to 98 seconds; Expression: Concerned; Audio tone: Warning; Intention: Cautionary advice; Gesture: Fingers crossed.” Code for this JSON file or other data object or structure may then be processed using the deep learning model, which may identify and score the gestures or other behavioral cues for likelihood of fraud, risk, or the like, and may provide an output risk or fraud score that may be compared to a threshold for riskiness or likelihood of fraud. The threshold may include multiple thresholds, such as one for a “low risk”, “medium risk”, or “high risk”, However, other tiered risk systems or rankings may also be used, which may include a different number of risk and/or fraud likelihood thresholds. When analyzing the output score by or from gesture recognition module 134, the confidence score from the multimodal model may also be used to offset, weight, or otherwise adjust the risk or fraud likelihood score, which may affect the risk or fraud designation based on the thresholds (e.g., by raising or lowering the score based on the confidence value or score).

Next, at step 212, summary and storage module 135 may provide compliance summarization, alerting, and/or data storage processes for the alerts, the detected gestures, the summaries and/or analysis of the gestures, and any additional relevant data. In some embodiments, summary and storage module 135 may include an alert management component that may be invoked and/or utilized to generate and transmit alerts and other notifications to users, endpoints, devices, and/or systems of compliance issues, fraud detection, and the like. The alert management component may be configured for compliance review and enforcement automation. This may be performed by automating the processes for compliance enforcement through user and/or system alerts, communication reporting and/or blocking, and/or assisting the service provider and/or fraud detection system with compliance requirements. For example, an alert generation component and/or system may flag video recordings having a particular risk or fraud likelihood designation for further review of detected abnormalities. While flagging and alerting for review may occur with certain designations, such as a medium risk designation, a higher designation may take harsher or more restrictive actions. For example, in some embodiments, an action to block further communications, alert an authority or administrator, or take another proactive action to prevent, limit, or unwind/reverse past, ongoing, or future fraud may be taken. For example, certain users may be blocked from conducting further video communications if video recordings are flagged as “high risk” until further review and/or action is taken.

Criteria for flagging may include set thresholds, deviations from normal or baseline, content, keywords or phrases including text strings (e.g., bank accounts, amounts or values, addresses, etc.), behavioral cues known to or likely used to conduct fraud, users involved in the video communication, and the like. As such, recordings may be classified as abnormal and blocked from further use or engagement by the user in further communications. Conversely, if a recording passes the risk and fraud detection checks and the predicted score is below the threshold, the recording may be forwarded for further processing, stored, and/or validated as normal, legitimate, or non-fraudulent. Thus, depending on the output of fraudulent activity detection from step 212, the video communications, or more specifically the recording of the video communications, as well as any users involved in the video communications, may be appropriately handled, at step 214. For example, a compliance enforcement action may be taken against those users, at step 214. As such, the system may be able to automatically detect, block, and report abnormal recordings, users, and the like, which may be used for compliance enforcement. This helps ensure tenants of fraud detection system 120 obtain the review and necessary analysis to remain complaint with laws, rules, and regulations, as well as reduce their loss and damage from fraud.

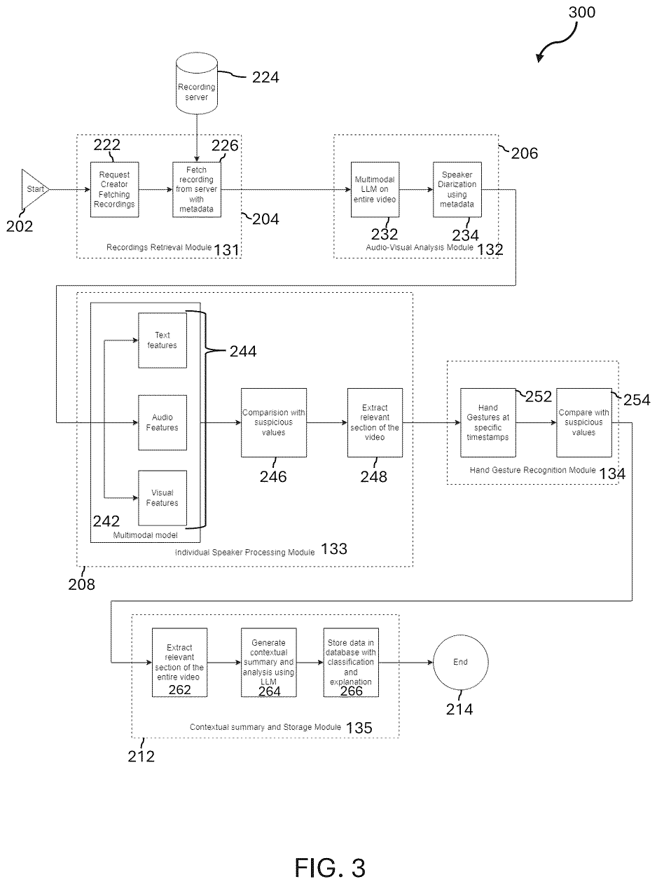

FIG. 3 is a simplified diagram 300 of the system components and processing modules from FIG. 2 shown in further detail according to some embodiments. Diagram 300 represents the components of gesture detection platform 130, which may be used to automated compliance alerts by detecting visual content of users that may include the users performing gestures or otherwise engaging in motions, activities, actions, or the like meant to bypass traditional audio and/or text analysis and convey messaging that may be used to engage in fraud or other malicious, illegal, or unauthorized behaviors. In this regard, processing by the components in diagram 300 begins at step 202 from diagram 200, which may represent an initiation of the components for processing a call, job, or task using gesture detection platform 130. The task may be associated with compliance review and enforcement of a video recording that has been created and/or stored. As such, step 202 may initiate a processing flow and pipeline that utilizes and executes recording retrieval module 131, audio-visual analysis module 132, individual speaker processing module 133, gesture recognition module 134, and summary and storage module 135 for automated compliance alerts of video communications having gestures or other behavioral cues being used for fraud. Diagram 300 of FIG. 3 therefore shows a more granular detail of diagram 200 from FIG. 2 with corresponding processing operations or tasks for handling video recordings using the multimodal LLMs and DNNs, as discussed herein.

Diagram 300 similarly begins with step 202 where the processing flow is executed, initiated, and/or loaded for execution by one or more processors of a fraud detection system, which may be a single or dedicated server group, cloud-based architecture, one or more machines utilized in a group or cloud computing environment, or the like. At step 204, a request creator 222 creates, for a recording server 224, a recording fetch request 226, such as a request, command, query, or the like to fetch and retrieve video recordings for a specific time period, user, tenant, or one or more other identifiers. Thus, at step 204, a request is generated to fetch recordings from recording server 224 by request creator 222. This request may be generated specifically to request and/or fetch the recordings for the current date, or the request may designate another data and/or set parameter for fetching a batch, group, or set of recordings. Recordings retrieval module 131 obtains a list of available recordings from recording server 224 based on the request along with the speaker metadata. The system iterates through each recording obtained from the server. Each recording is then sent to audio-visual analysis module 132 for further processing. In some embodiments, image, video, and/or frame extraction and/or preprocessing may occur. For example, with frame extraction, a process may obtain a set of frames, or images from video recordings, which may be used for individual processing. Initial image processing may be applied to the videos and/or extracted frames or images so that they may be prepared for LLMs and/or other AIs trained for image, object, person, or gesture recognition, as well as speech detection, speaker diarization, text analysis, and other tasks of the multimodal LLM. As such, preprocessing operations may include applying preprocessors, which may correspond to one or more image preprocessors that may adjust, scale, and convert the images and/or pixel data in the images into formats or representations that may assist with data analysis.

At step 206, a multimodal LLM 232 is applied on each recording in their entirety, or at least the important, pertinent, flagged, or authorized portions of the recording that may be analyzed. This may include passing the entire video data to multimodal LLM 232 to analyze if there is anything suspicious in the video. This step ensures that only suspicious videos (e.g., those containing certain keywords, actions, or anomalies) are processed further, reducing unnecessary computation and focusing resources on relevant content. If suspicious activity, gestures, or the like is identified in the video, audio-visual analysis module 132 may proceed to speak diarization 234 whereby each individual speaker's segments are extracted and utilized for further analysis by a second multimodal LLM 242. However, in other embodiments, multimodal LLMs 232 and 242 are the same LLM, and instead another pass of the data through multimodal LLM 232 may be performed. However, with the second pass and/or each subsequent pass, the data may be provided with different instructions or prompts based on a corresponding task for completion so that the LLM is properly instructed for task completion. For speaker diarization 234, metadata of the video is extracted to obtain speaker information and the corresponding timestamps. The metadata may help to map speaker's identities and/or identifiers to their names or other identifiers that may be displayed during the video communication.

Thereafter, for speaker diarization 234 speaking intervals of the individual speakers are determined using the metadata file to identify the start and end time of each speaker. Since conversations in a video are not continuous, there may be gaps between a speaker's speech and their turn to speak, which may be reflected as silence between speakers. To properly handle these gaps and maintain the structure of the conversation without awkward cuts, speaking segments are identified and silence duration is detected by computing the gaps between speaking segments. A speaker's audio is then determined by isolating the speaker's voice from the full audio track while preserving silence where needed. This may be overlaid on the video communication using corresponding metadata and timestamps, thereby replacing the original sound so that the speaker's voice is clear and isolated in the final video. This step creates seamless video output with synchronized visuals and audio.

The segmented, restructured, and processed video segments, each having the corresponding audio replaced, is provided to individual speaker processing module 133, at step 206. Individual speaker processing module 133, at step 208, may first extract and/or determine feature data for model features, such as ML model or LLM features in data sets or data records, The input may include speaker-separated video segments where each participant's speech may be isolated. Second multimodal LLM 242 that processes model features 244 including text features, audio features, and/or visual features, processes the speaker's visual expressions, audio tone, and intention across the entire video. Second multimodal LLM 242 assigns labels to different sections, e.g., at 20 seconds to 30 seconds, the speaker was positive, enthusiastic, and shared information. The model also computes overall dominant values (e.g., the speaker was mostly neutral with occasional excitement).

To perform this analysis and classification of the speaker, the speaker's speech, and/or the speaker's mannerisms and behavioral cues, feature data for the speaker's expressions, audio tone, and intentions may be extracted. For an analysis of data for model features 244 by second multimodal LLM 242, expressions and data used for analysis of user facial expressions may be determined, which can be used to detect emotions, states, feelings, or the like that may be associated with those facial expressions (e.g., happy, neutral, concerned, serious, surprised, etc.). Audio tone detection and features for audio tones may be used to determine tone characteristics including enthusiastic, warning, calm, aggressive, formal, etc. Additionally, features and data for intention recognition may be used to identify the intent behind speech, e.g., sharing information, providing a warning, giving cautionary advice, storytelling, etc. Each detected expression, tone, and intention may be mapped to timestamps in the video. A dominant trend may be further calculated for the entire speaker video.

Thereafter, the extracted values are compared against suspicious values 246. Individual speaker processing module 133 may load suspicious values 246, which contains flagged values for expression (e.g., concerned, nervous, aggressive), audio tone (e.g., warning, urgent, defensive), and/or intention (e.g., cautionary advice, alerting, threatening). Each timestamped segment may be checked against this list of suspicious values 246 and if the score meets or exceeds a threshold for compliance alerting and review, the segment may be packaged as a data container, file, object, or other data that can be transmitted and processed. The data container may be provided to gesture recognition module 134 for handling. For example, if any segment matches suspicious values 246, such as by having a similarity score that meets or exceeds a threshold and/or having a likelihood of fraud score that meets or exceeds a threshold, that segment may be marked for cropping and/or extraction. Suspicious video segments may be cropped or segmented from the video recording and used to create a relevant section 248 of the video recording of the video communication. The full-length video is taken as input and, using the timestamps from the above block, individual speaker processing module 133 may locate relevant section 248, and any other relevant sections, that need to be cropped or segmented from the full-length video to facilitate review, investigation, storage for later retrieval, or the like. A new video is created from the cropped segment of relevant section 248, which has suspicious content of the individual participant. The final output may include a cropped video with suspicious content, ready for further processing.

The output of individual speaker processing module 133 after extraction of relevant section 248 may be provided to gesture recognition module 134 next in diagram 300. Gesture recognition module 133 includes a DNN 252 configured to detect and classify hand gestures or other gestures at corresponding timestamps. In this regard, gesture recognition module 134 may apply DNN 252 to each suspicious video segment to detect, identify, and classify hand gestures, such as “fingers crossed,” “thumbs up/down,” “open palm (signaling stop),” and the like. The gestures identified by DNN 252 are compared with the values in a suspicious list 254. If a match is found in suspicious list 254, gesture recognition module 134 may flag the segment as highly suspicious. The process concludes after identifying and comparing the gestures in the video so that the output of DNN 252 is used to correlate gestures in the video to known values in suspicious list 254. As such, the output of the gesture recognition by gesture recognition module 134 may be provided for compliance review, alerting, and/or enforcement, at step 212, to summary and storage module 135. Additionally, a relevant video section 262 taken directly from the video recording (e.g., without additional processing, although the processed and/or diarized segment may also or instead be used) for the gesture is extracted and used for packaging and storage so that compliance review may later directly access the corresponding section having the compliance issue and/or alert.

As such, during step 212, summary and storage module 135 may extract the suspicious section (relevant video section 262) from the original video while preserving surrounding context. Summary and storage module 135 may create a contextual video segment providing background for suspicious behavior, where the background may correspond to a summary and/or other natural language explanation of the video segment, reason the video segment is flagged, and/or suspicious behavior and/or gesture(s) in the video segment. To generate a summary, a summarization LLM 264 may be used to analyze the conversation and generate a summary, as well as topics and/or keywords related to suspicious behavior. Summarization LLM 264 may identify shifts in tone and intent before and after the suspicious event. The collected summary, keywords, topics, gestures, and the like may be sent to a database 266 using an API. The API may be a general or a specific API designed to interact with database 266, facilitating the storage of metadata. This step involves making API calls to store each piece of data in the appropriate database fields, ensuring that the information is organized and retrievable for future use.

In summary, after initiation or start of the process at step 202, diagram 300 begins the processing flow with a request to fetch recordings at step 204 and continues to where the recordings are sent to the multimodal LLM to identify if there is any suspicious content in the video. Speaker diarization is then performed on the entire video using metadata, at step 206. Thereafter, at step 208, diarized video of each speaker is then sent to multimodal LLM to extract expressions, audio tone and intentions from visual, audio and textual features along with the timestamps. These features are then compared with the suspicious values in the predefined list. Based on timestamps, the relevant suspicious section(s) of the video is/are cropped. At step 210, a trained deep learning model is used to detect and classify gestures from the cropped video. Detected gestures are then compared with suspicious values in the list. Diagram 300 concludes the processing flow at step 212 where, based on the timestamp from diarized video, the relevant section is extracted from the entire video which has suspicious features and gestures. Since the entire video has context about suspicious conversations, an LLM is used to generate a contextual summary and analysis with keywords and topics. This data is then stored using an API to a storage component, database, or the like, and the process ends at step 214.

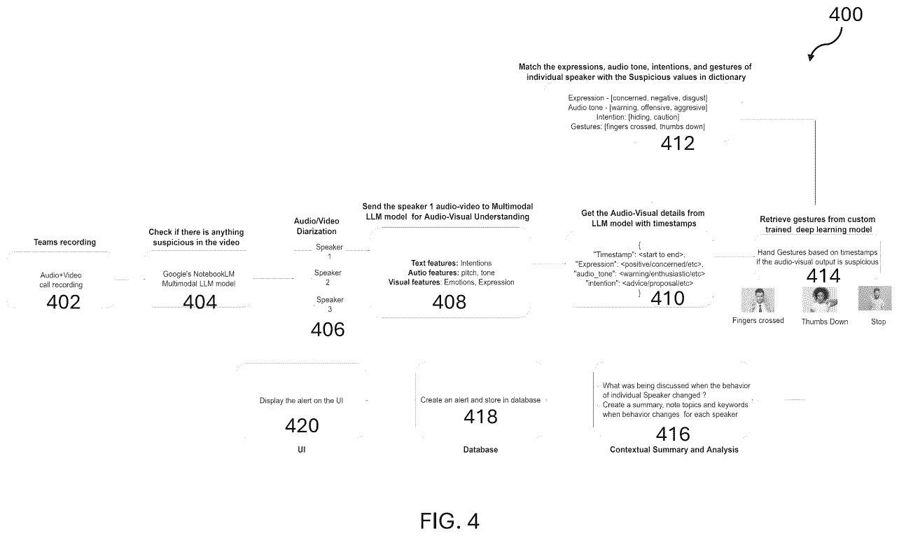

FIG. 4 is a simplified diagram of an exemplary processing flow 400 for detecting behavioral cues in video communications using a multimodal artificial intelligence system for automated compliance enforcement according to some embodiments. Note that one or more steps, processes, and methods described herein of processing flow 400 may be omitted, performed in a different sequence, or combined as desired or appropriate based on the guidance provided herein. Processing flow 400 include operations executable by gesture detection platform 130 that performs compliance review of one or more video communications to detect visual content of gestures and other behavioral cues that may be used in the course of conducting fraud. One or more of the software components and/or executable operations in processing flow 400 may be implemented, at least in part, in the form of executable code stored on non-transitory, tangible, machine-readable media that when run by one or more processors may cause the one or more processors to perform the corresponding processes, operations, and steps of such component. In some embodiments, processing flow 400 can be performed by one or more computing devices discussed in environment 100 of FIG. 1.

In processing flow 400, start 302 initiates execution and use of the processes and modules of gesture detection platform 130, beginning with retrieving a call recording 402 having audio and video data of two or more users engaging in a conversation or other communications, such as a video call or conference call between users. When fetched, recordings are retrieved from the server along with the speaker metadata. The recordings are sent to Multimodal LLM 404 to identify if there is any suspicious content in the video. This may be done for speakers 406 individually, and, as such, speaker diarization is then performed on the entire video using metadata so that each of speakers 406 may be identified. In order to generate data containers 410, diarized video of each speaker is sent to a multimodal LLM, which may be multimodal LLM 404 or another multimodal LLM. The multimodal LLM may extract features 408 corresponding to expressions, audio tone, and intentions from visual, audio, and textual features with corresponding timestamps. Data containers 410 or other data files and the like may be generated having these features and other extracted data. Data containers 410 having feature data for features 408 with timestamps may then be compared with suspicious values in a predefined list 412.

Based on the timestamps, relevant suspicious sections of the video may be segmented based on matching features 408 in data containers 410 to those suspicious values in predefined list 412. Output of this process may be provided to a trained deep learning model 414 for gesture recognition, which may be used to detect and classify gestures from the cropped and/or segmented video. Detected gestures may then be compared with suspicious values in the list. Based on the timestamp from diarized video, a summary and analysis 416 may extract the relevant section from the entire video that includes the suspicious features and gestures. Since the entire video has context about suspicious conversations, gestures, and the like, an LLM may be used to generate contextual summary and analysis 416 with keywords and topics. This data is then stored using an API and storage component.

After gesture detection and classification using trained deep learning model 414, risk scoring may be performed to calculate a risk score based on the expressions, audio tone, intentions and gestures of the individual participants. For threshold comparisons, the risk score may be compared to a threshold to determine if the participant or conversation is risky or not risky (e.g., indicative of fraud or non-fraudulent). Depending on the threshold, the type of the risk may be categorized, such as low, medium, or high risk. In some embodiments for compliance enforcement and/or fraud prevention and mitigation, a case may be created having details about suspicious behavior, which may correspond to and/or include an alert 418 that is similarly stored and/or transmitted to one or more regulatory or compliance officers. For example, a detailed report may be created of the suspicious behavior detected for low, medium and high-risk users, such as employees of a tenant company of the fraud detection system. Each report may include information regarding the expressions, tone, intentions, gestures, contextual summary, keywords, topics and conversation analysis results. For high-risk employees, immediate action may be taken, such as by escalating to the compliance officers, blocking all the channels of communication for high-risk suspicious employees including emails, chats, attachments, voice calls, etc., and/or automatically sending notifications to administrators or relevant stakeholders, providing the report and details of suspicious behavior. Such notifications, as well as other actions taken with regard to the risk score, threshold, and compliance action may be presented in a UI 420.

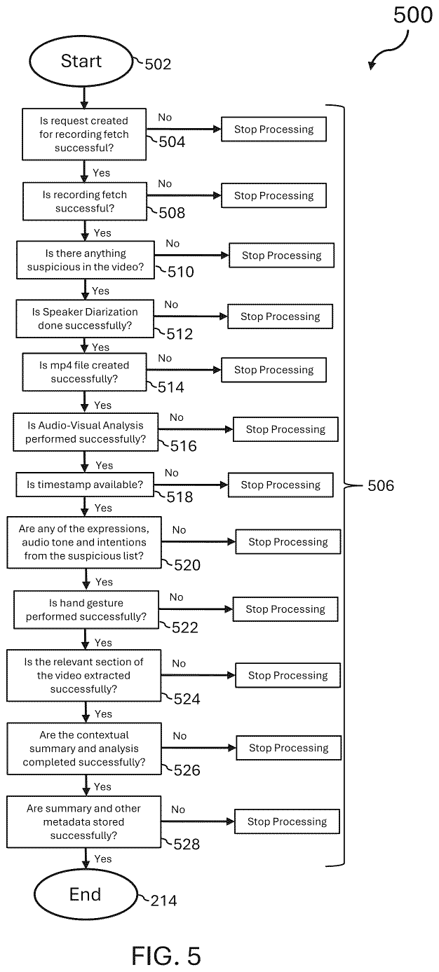

FIG. 5 is a simplified diagram of an exemplary flowchart 500 for context-aware behavioral cue monitoring using multimodal AI models including LLMs for automated compliance enforcement in video communications according to some embodiments. Note that one or more steps, processes, and methods described herein of flowchart 500 may be omitted, performed in a different sequence, or combined as desired or appropriate based on the guidance provided herein. Flowchart 500 of FIG. 5 includes operations executable by gesture detection platform 130 that performs gesture and other behavioral cue analysis for fraud detection, compliance alerting, and other anomalous activity detection tasks, as discussed in reference to FIGS. 1-4. One or more of steps 502-528 of flowchart 500 may be implemented, at least in part, in the form of executable code stored on non-transitory, tangible, machine-readable media that when run by one or more processors may cause the one or more processors to perform one or more of steps 502-528. In some embodiments, flowchart 500 can be performed by one or more computing devices discussed in environment 100 of FIG. 1.

Flowchart 500 begins at step 502 where the operations for multimodal analysis of video communications are initiated. At step 504 of flowchart 500, it is determined whether a request for a recording fetch is successfully created. A request may correspond to an API call or other data communication that requests another system provide data back to the requester. In such embodiments, gesture detection platform 130 may correspond to the requester, specifically, recordings retrieval module 131, which may generate a request on command, in response to a scheduled job or task for recording review, and/or in response to an external signal or event, such as ending of the video communication, rendering of the video recording for the communications, storage of the recording, detection of a fraudulent event or activity associated with one of the users or the video communication, or other signal or event. The request may be made to a database and/or data storage component, such as database 126. If the request has not been created, or is unsuccessfully created (e.g., without proper authentication or authorization for recording access, with an improper, unknown, or non-existent file name or path for the video recording, etc.), then flowchart 500 may end at step 506 where processing is stopped and the multimodal analysis of gestures and/or behavioral cues is ended prior to successful completion of all processing steps of flowchart 500. In this regard, step 506 may be repeated or returned to during the discussion of flowchart 500 herein when data processing may end at unsuccessful completion of a step.

However, if the request is successfully created at step 504, flowchart 500 proceeds to step 508 where it is determined whether the recording is successfully fetched. Using the request created at step 504, a database or other data storage component, including cloud-based storages, data lakes for streaming data recordings, and the like, may be queried and requested to retrieve and provide a video recording. The video recording may correspond to an audiovisual data file with metadata that indicates different audio inputs and/or outputs at different times in the recording. The video recording may include, e.g., two or more users that are identifiable and may be performing different actions or activities including gestures, which may be analyzed for fraud. If the recording is not successfully retrieved, such as if the recording has not finished rendering, has not yet been stored (or was not stored), does not exist, or authorization to access is not permitted, then flowchart 500 may proceed back to step 506 where processing ends. However, if the recording is successfully retrieved and provided back to recordings retrieval module 131, recordings retrieval module 131 may continue to step 510 where it is determined, by audio-visual analysis module 132, whether there is anything initially suspicious in the video recording. Audio-visual analysis module 132 may determine if the video, in its entirety, includes audio, visual, or text content that is sufficiently anomalous, fraudulent, or otherwise unauthorized to trigger, meet, or exceed a threshold or other score, value, or the like that indicates a sufficient likelihood of fraud or suspicious activity.

In this regard, a multimodal LLM or other multimodal model may process and analyze the entire video recording of the video communication, identifying whether any specific parts or portions are suspicious and/or the video as a whole is suspicious. Since this phase involves only an initial review without analysis of individual user gestures and context to the gestures, no alerts, summaries, or other compliance review and/or enforcement data may be generated and/or transmitted to users or other external systems. Thus, audio-visual analysis module 132 may utilize the multimodal LLM to perform a suspicious activity check without or independent of notifying users or creating/enforcing compliance actions and alerts. If nothing suspicious is detected in the video recording, flowchart 500 returns to step 506 where processing ends.

However, if there is suspicious activity detected, flowchart 500 proceeds to step 512, where it is determined whether speaker diarization is successfully performed. Speaker diarization may be performed to individually segment each speaker in the video recording, thereby creating video segments or portions from the main or master video recording of the entire video communication, where each segment or portion corresponds to the audio, visual, and/or text data for a particular user that is speaking, or moving, at that point in time, or timestamp in the recording, and/or at or between specific timestamps. Speaker diarization may be performed by audio-visual analysis module 132, which may utilize metadata for the video indicating different inputs and/or speakers at different timestamps in the video recording. This may also include determining speaking intervals for users, processing and/or eliminating silence and other gaps in speech, and extracting the speaker's audio, as well as their video and/or text portions. If speaker diarization cannot be successfully performed, flowchart 500 ends at step 506.

However, if speaker diarization is successful and diarized audio-video content, segments, portions, or the like is successfully extracted, created, and/or determined, then at step 514, it is determined whether an MPEG Part 14 (mp4) format file or other video format file has been successfully created of the now diarized video recording of the video communication session between the two or more users. The video file and format may be generated for processing by individual speaker processing module 133 and/or gesture recognition module 134, which may process the video file in the particular format in order to provide gesture recognition and analysis for compliance review, enforcement, and fraud detection. As such, if the video file and format cannot be created, flowchart 500 proceeds to step 506 where processing ends. However, if successfully created, at step 516, it is determined whether an audio-visual analysis is successfully performed. For example, individual speaker processing module 133 may process the diarized audio-visual content of each individual speaker or other user (e.g., including users that may only move or may communicate through inaudible or non-verbal means) using another multimodal LLM configured to generate

For example, the first LLM used by audio-visual analysis module 132 may be trained for suspicious activity detection in video recordings, while the second LLM used by individual speaker processing module 133 nay be trained to analyze individual speakers for detection of blacklisted, suspicious, fraudulent, or risky gestures and other behavioral cues. In this regard, the second LLM may identify any gestures or other behavioral cues of users in the diarized and/or segmented video recording for each speaker or other user, as well as whether any gestures or other behavioral cues by a speaker indicate fraud using a watchlist or other exemplary data of suspicious gestures and/or behavioral cues. If no such cues are found of one or more speakers by individual speaker processing module 133, then flowchart 500 may return to step 506 where processing is stopped and flowchart 500 ends. However, if a gesture is found to sufficiently match a suspicious gesture or other example of potentially fraudulent behavioral cues, then flowchart 500 may proceed to step 518 where it is determined whether a timestamp of all potentially fraudulent gestures have been determined and are available. Each timestamp may be used to specifically identify a time in the video recording where a potentially fraudulent activity or action can be found and reviewed. If timestamps are unavailable for the different gestures and/or behavioral cues of the user in the diarized audio-visual content, segments, or the like of a speaking user, then flowchart 500 may end at step 506 where processing stops for failure to have timestamps or other data sufficient to identify when, where, and who performs the suspicious or potentially fraudulent gesture or other behavioral cue.

In this regard, the timestamp may be used for generation of data containers, files, or objects that may be created by gesture recognition module 134 and/or summary and storage module 135 when determining whether a gesture, given the context and usage of the gesture in the conversation or communications between the users or other parties involved in the video communication, is indicative of fraud or sufficiently suspicious to require compliance review and enforcement. Individual speaker processing module 133 may be configured to, at step 520, using the identified gestures and timestamps of those gestures, determine whether the gestures, along with the context of performing the gestures, are sufficiently suspicious to warrant further review and analysis by a specifically trained DNN or other deep learning model for gesture identification. In this regard, the second LLM, a multimodal LLM trained for context-aware suspicious gesture identification, may be configured to analyze the expression, audio tone, intention, and/or other flagged values from the segment for the gesture to determine whether such data is sufficiently suspicious to warrant a further analysis using a deep learning model trained for identification of gestures including gesture meaning and usage, such as for fraud or to otherwise alter other language when engaging in fraud.

In this regard, the multimodal LLM may score the segments of diarized content according to each gesture and determine if the score meets or exceeds a threshold. Thresholds may be set manually by a compliance review officer, administrator, agent, or similar user that may configure the compliance review and alert system for analysis of visual content. However, in other embodiments, thresholds may be intelligently determined based on past violations of compliance laws, rules, or regulations by video calls and/or corresponding visual content, where gestures may be analyzed and/or annotated with what violates compliance requirements and what does not. If no gestures meet the suspicious threshold requirement, flowchart 500 proceeds to step 506 where processing ends. However, if gestures do meet or exceed the threshold, then gesture recognition module 134 may be invoked and may be utilized for deeper analysis of the gesture and gesture's meaning in the context of the video.

As such, at step 522, it is determined whether a gesture identified as potentially fraudulent or used to engage in fraud was successfully performed in the video. That is, gesture recognition module 134 may determine whether the hand (or other body part, object, etc.) gesture matches and/or is sufficiently similar to known fraudulent, suspicious, blacklisted, or otherwise unauthorized gestures. This may be done by a deep learning model, such as a DNN, trained specifically for identification of gestures and comparison of gestures to a list of unauthorized gestures. In this regard, the DNN may be trained for object and image detection, comparison, and analysis, enabling the DNN to infer similarities between known examples of fraudulent or unauthorized gestures and the gesture detected in the video. If the gestures are not properly performed in the video, such as if the gesture appears, but is not, similar to a fraudulent gesture, flowchart 500 returns to step 506 where processing ends for the present gesture and/or video recording. However, if identified, flowchart 500 continues to step 524 where successful extraction of the relevant section of the video is analyzed for the performance of the gesture so that the section may be specifically linked to and/or stored with a summary and/or analysis of the fraudulent gesture.

As such, at step 526, it is determined whether a contextual summary and analysis of the gesture and video segment is successfully completed. An LLM, such as a summarization LLM or other generative AI, may generate a natural language summary and/or analysis of the gesture and context that indicates fraud. This may include text that may be readable by a layperson, by a specialist or compliance officer, and/or by a user with little or no computer science and/or computer code training. Instead, the textual summary may be generated in natural language for general human consumption. At step 528, this summary and metadata for the timestamps, speaker, or other data of the relevant section of the video for the gesture may then be determined to be stored successfully for future reference and/or compliance actions and/or enforcement. Alternatively, each of steps 524, 526, and 528, if unsuccessful, may result in flowchart 500 instead ending at step 506 where processing is ended.

For example, with compliance actions that may be automatically executed, if the recording is determined to be a normal recording and passes the suspicious or anomalous gesture detection checks, such as if the aggregated score is below or at the threshold, the recording is forward for further storage and processing as a non-fraudulent video recording, which may include storing and/or making available for playback. However, if the aggregated score exceeds the threshold, the recording may be classified as abnormal, and the recording may be blocked from further processing so that a compliance review may be initiated and/or the recording may be flagged for a compliance review. From steps 526 and 528, a detailed report of the detected gestures and/or fraud may be created including frame analysis results and scores. With or after storage, notifications may be automatically sent to administrators or relevant reviewers, providing the generated report and details of the blocked recording for compliance review.

As discussed above and further emphasized here, FIGS. 1, 2, 3, 4, and 5 are merely examples of fraud detection system 120 and corresponding methods for automated compliance alerts and enforcement of video communications that may include behavioral cues of users using a context-aware multimodal LLM or other AI model, which said examples should not be used to unduly limit the scope of the claims. One of ordinary skill in the art would recognize many variations, alternatives, and modifications.

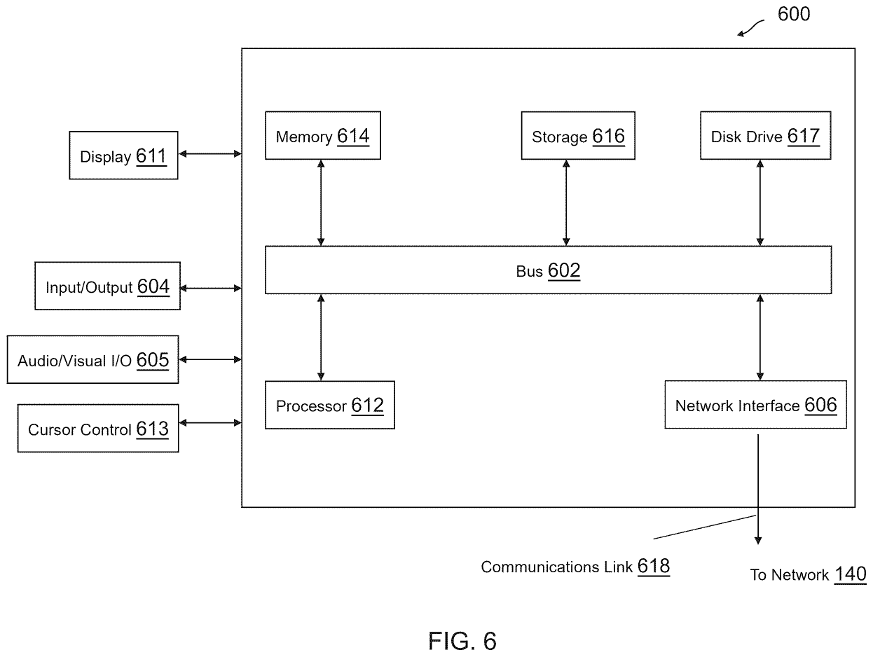

FIG. 6 is a block diagram of a computer system 600 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals. Audio/visual I/O component 605 may allow the user to hear audio, and well as input and/or output video. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A fraud detection system configured to automatically detect compliance violations from behavioral cues performed by users during video communications, the fraud detection system comprising:
a processor and a non-transitory computer readable medium operably coupled thereto, the non-transitory computer readable medium comprising a plurality of instructions stored in association therewith that are accessible to, and executable by, the processor, to perform visual analysis operations which comprise:
accessing a video communication between two or more users, wherein the video communication includes video data of at least a first user of the two or more users;
determining, by a first large language model (LLM), that the video data includes an indication of suspicious activity based on the behavioral cues performed by at least the first user during the video communication;
extracting feature data for a plurality of model features of a second LLM from the video data, audio data of the video communication, and text data shared during the video communication, wherein the plurality of model features are associated with the behavioral cues;
identifying, based on the feature data and the second LLM, one or more segments of the video communication having a corresponding one of the behavioral cues meeting or exceeding a threshold for suspicious behavioral cue identification;
extracting, by the second LLM from the video data, the audio data, and the text data, a data container comprising data from each of the one or more segments identified;
performing a gesture recognition process on the one or more segments using a deep learning model, the feature data, and the data container;
generating a summary having an analysis of the one or more behavioral cues meeting or exceeding the threshold; and
outputting the summary for an automated compliance action based on whether the analysis indicates one or more of the compliance violations are present in the video communication.

2. The fraud detection system of claim 1, wherein the second LLM comprises a multimodal LLM configured to handle a plurality of types of data including the video data, the audio data, and the text data, and wherein the extracting the data container comprises:
determining, by the second LLM, a timestamp at which the corresponding one of the behavioral cues starts and ends in the video data of the video communication;
extracting, by the second LLM, an expression of the first user based on the video data;
extracting, by the second LLM, an audio tone of the first user based on the audio data; and
extracting, by the second LLM, an intention of the first user when performing the corresponding one of the behavioral cues based on the video data, the audio data, and the text data.

3. The fraud detection system of claim 1, wherein the behavioral cues comprise at least one of a gesture made using a body part, a motion made using the body part, or a facial expression, and wherein the behavioral cues are further of a second user communicating with the first user during the video communication.

4. The fraud detection system of claim 1, wherein, before the extracting the feature data, the visual analysis operations further comprise:
performing a speaker diarization of the first user in the video communication based on the audio data and the video data, wherein the speaker diarization isolates the first user from a second user in the video communication; and
generating a first plurality of segments of the video communication that include the first user based on the speaker diarization,
wherein the feature data is extracted from the first plurality of segments.

5. The fraud detection system of claim 4, wherein the visual analysis operations further comprise:
determining a response by the second user based on at least one of a second plurality of segments of the video communication generated from the speaker diarization,
wherein the gesture recognition process is further performed based on the response.

6. The fraud detection system of claim 1, wherein the accessing the video communication comprises:
generating a request to fetch a plurality of recordings of a subset of the video communications occurring during a time period from a call processing server; and
fetching the plurality of records from the call processing server using the request,
wherein the accessing the video communication comprises accessing a recording of the video communication from the plurality of recordings.

7. The fraud detection system of claim 1, wherein the summary indicates that the video communication is compliant with one or more compliance policies for the video communications analyzed by the fraud detection system, and wherein the automated compliance action comprises processing the video communication as a non-fraudulent communication.

8. The fraud detection system of claim 1, wherein the summary indicates that the video communication is non-compliant with one or more compliance policies for videos communications analyzed by the fraud detection system, and wherein the automated compliance action comprises at least one of:
flagging the video communication for a review,
blocking at least one of the first user or a second user participating in the video communication from further communications for a time period or until the review,
reporting at least one of the video communication, the first user, or the second user to an authority.

9. The fraud detection system of claim 1, wherein the data container comprises an identifier for each of a timestamp, an expression, an audio tone, and an intention determined for the corresponding one of the behavioral cues.

10. A method to automatically detect compliance violations from behavioral cues performed by users during video communications by a fraud detection system, which method comprises:
accessing a video communication between two or more users, wherein the video communication includes video data of at least a first user of the two or more users;
determining, by a first large language model (LLM), that the video data includes an indication of suspicious activity based on the behavioral cues performed by at least the first user during the video communication;
extracting feature data for a plurality of model features of a second LLM from the video data, audio data of the video communication, and text data shared during the video communication, wherein the plurality of model features are associated with the behavioral cues;
identifying, based on the feature data and the second LLM, one or more segments of the video communication having a corresponding one of the behavioral cues meeting or exceeding a threshold for suspicious behavioral cue identification;
extracting, by the second LLM from the video data, the audio data, and the text data, a data container comprising data from each of the one or more segments identified;
performing a gesture recognition process on the one or more segments using a deep learning model, the feature data, and the data container;
generating a summary having an analysis of the one or more behavioral cues meeting or exceeding the threshold; and
outputting the summary for an automated compliance action based on whether the analysis indicates one or more of the compliance violations are present in the video communication.

11. The method of claim 10, wherein the second LLM comprises a multimodal LLM configured to handle a plurality of types of data including the video data, the audio data, and the text data, and wherein the extracting the data container comprises:
determining, by the second LLM, a timestamp at which the corresponding one of the behavioral cues starts and ends in the video data of the video communication;
extracting, by the second LLM, an expression of the first user based on the video data;
extracting, by the second LLM, an audio tone of the first user based on the audio data; and
extracting, by the second LLM, an intention of the first user when performing the corresponding one of the behavioral cues based on the video data, the audio data, and the text data.

12. The method of claim 10, wherein the behavioral cues comprise at least one of a gesture made using a body part, a motion made using the body part, or a facial expression, and wherein the behavioral cues are further of a second user communicating with the first user during the video communication.

13. The method of claim 10, wherein, before the extracting the feature data, the method further comprises:
performing a speaker diarization of the first user in the video communication based on the audio data and the video data, wherein the speaker diarization isolates the first user from a second user in the video communication; and
generating a first plurality of segments of the video communication that include the first user based on the speaker diarization,
wherein the feature data is extracted from the first plurality of segments.

14. The method of claim 13, further comprising:
determining a response by the second user based on at least one of a second plurality of segments of the video communication generated from the speaker diarization,
wherein the gesture recognition process is further performed based on the response.

15. The method of claim 10, wherein the accessing the video communication comprises:
generating a request to fetch a plurality of recordings of a subset of the video communications occurring during a time period from a call processing server; and
fetching the plurality of records from the call processing server using the request,
wherein the accessing the video communication comprises accessing a recording of the video communication from the plurality of recordings.

16. The method of claim 10, wherein the summary indicates that the video communication is compliant with one or more compliance policies for the video communications analyzed by the fraud detection system, and wherein the automated compliance action comprises processing the video communication as a non-fraudulent communication.

17. The method of claim 10, wherein the summary indicates that the video communication is non-compliant with one or more compliance policies for videos communications analyzed by the fraud detection system, and wherein the automated compliance action comprises at least one of:
flagging the video communication for a review,
blocking at least one of the first user or a second user participating in the video communication from further communications for a time period or until the review,
reporting at least one of the video communication, the first user, or the second user to an authority.

18. The method of claim 10, wherein the data container comprises an identifier for each of a timestamp, an expression, an audio tone, and an intention determined for the corresponding one of the behavioral cues.

19. A non-transitory computer-readable medium having stored thereon computer-readable instructions executable to automatically detect compliance violations from behavioral cues performed by users during video communications by a fraud detection system, the computer-readable instructions executable to perform visual analysis operations which comprise:
accessing a video communication between two or more users, wherein the video communication includes video data of at least a first user of the two or more users;
determining, by a first large language model (LLM), that the video data includes an indication of suspicious activity based on the behavioral cues performed by at least the first user during the video communication;
extracting feature data for a plurality of model features of a second LLM from the video data, audio data of the video communication, and text data shared during the video communication, wherein the plurality of model features are associated with the behavioral cues;
identifying, based on the feature data and the second LLM, one or more segments of the video communication having a corresponding one of the behavioral cues meeting or exceeding a threshold for suspicious behavioral cue identification;
extracting, by the second LLM from the video data, the audio data, and the text data, a data container comprising data from each of the one or more segments identified;
performing a gesture recognition process on the one or more segments using a deep learning model, the feature data, and the data container;
generating a summary having an analysis of the one or more behavioral cues meeting or exceeding the threshold; and
outputting the summary for an automated compliance action based on whether the analysis indicates one or more of the compliance violations are present in the video communication.

20. The non-transitory computer-readable medium of claim 19, wherein the second LLM comprises a multimodal LLM configured to handle a plurality of types of data including the video data, the audio data, and the text data, and wherein the extracting the data container comprises:
determining, by the second LLM, a timestamp at which the corresponding one of the behavioral cues starts and ends in the video data of the video communication;
extracting, by the second LLM, an expression of the first user based on the video data;
extracting, by the second LLM, an audio tone of the first user based on the audio data; and
extracting, by the second LLM, an intention of the first user when performing the corresponding one of the behavioral cues based on the video data, the audio data, and the text data.
